(19) United States
(12) Patent Application Publication
(10) Pub. No.: US 2003/0182175 A1
(43) Pub. Date: Sep. 25, 2003

(54) Methods and systems for selling goods and services

(75) Inventors: John V.W. Buie, Scottsdale, AZ (US); Susan Kearney, Falls Church, VA (US)

Correspondence Address: Squire, Sanders & Dempsey L.L.P., Two Renaissance Square, 40 North Central Avenue, Suite 2700, Phoenix, AZ, 85004-4498, US

(73) Assignee: PainPowerFit, Inc.

(21) Appl. No.: 10/105,103

(22) Filed: Mar. 21, 2002

(51) Int. Cl. G06F 17/60

(52) U.S. Cl. 705/10

(57) ABSTRACT

Method and systems of qualifying opportunities for change are disclosed wherein certain parameters of each opportunity for change are evaluated against similar parameters of past or theoretical successes. If an opportunity for change does not qualify in comparison to one or more historical success, it is abandoned in favor of an opportunity for change that does qualify. In one aspect the opportunity for change is closing a sale to a sales prospect and nine specific elements of the sales prospect are rated and compared to similar ratings of previous successes. The nine elements relate to three different parameters including: (1) an opportunity or problem of the prospect; (2) a decision maker of the prospect; and (3) a fit of a solution proposal to address the opportunity or problem.

### COPYRIGHT NOTICE AND AUTHORIZATION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

1. Field of the Invention

The present invention relates to methods and systems for pursuing opportunities of change, including among other things, methods and systems for: (i) increasing sales revenues; (ii) decreasing wasteful time in sales endeavors; (iii) improving the accuracy of sales forecasting; (iv) streamlining sales processes, and (v) teaching others how to do all of the above. In particular, the methods and systems of the present invention focus on evaluating potential opportunities for change with specific qualification criteria and pursuing only those opportunities that meet the qualification criteria.

2. Related Art

Throughout history people have endeavored to sell goods, services and/or ideas to others. At present, many billions of dollars and countless man-hours are spent each year by industries and professionals to improve the results of their selling and lobbying efforts with, for the most part, insignificant results. This is due primarily to the time and effort wasted by agents of change on deals that might, but probably will not, close. As used herein, an “agent of change” or “agent” means any person or entity, or group thereof, that pursues opportunities for change or imposes on others, a change relating to the agent's ideas, goods or services, or those of their employer or affiliated companies and organizations. Merely by way of example, as opposed to limitation, an agent of change might sell: airplanes, toys, computers, widgets or other goods and products; accounting, business, labor, scientific, artistic, medical or legal services; patentable or non-patentable ideas or concepts and so on. An “opportunity for change” is any opportunity to make a choice. For example, an opportunity for change may be a choice whether to buy or not buy Goods.

Referring to FIG. 1, a typical process used by agents of change for selling includes: (i) identifying 10 prospective customers or “leads” for its products, services and/or ideas (for simplicity, individually and/or collectively referred to hereinafter as “Goods”) ; (ii) targeting 20 each lead with a sales pitch on why the lead should buy the agent's Goods 15; and, if the customer is willing to talk to, meet with, or otherwise “open the door” to the agent, (iii) designating the customer as a potential sale and placing the potential sale in a sales pipeline 25. A sales pipeline is basically an accounting system used by sales, management or accounting professionals to project sales performance and revenues for an organization. The projected sales revenues are often used to determine projected earnings and other information important in assessing the overall well being of the company (e.g., for estimating earnings per stockholder share).

Using known methods, an agent of change may coerce, manipulate and/or otherwise do anything to close each potential sale in the pipeline, usually within a certain period of time, e.g., by the end of the quarter 30, 40. Only if the agent is positive the deal will not close 20, 35 or the deal closes 45, does the agent move on 50 to another opportunity.

By way of example, a sales manager for a computer manufacturer may identify prospective customers as anyone who uses, owns or buys computers, and target the same with its sales pitch. In this example, assume the computer manufacturer identifies one hundred thousand prospective customers using this standard. The manager's sales force then targets the one hundred thousand prospective customers with its sales pitch hoping that some percentage, perhaps five to ten percent of the prospective customers it targets, will actually buy Goods from the computer manufacturer. The sales pitch may be anything from contacting the customer in person or by telemarketing, or by advertising directed atthe prospective customer, for example magazine ad or direct mail.

A problem arises in prior art selling techniques because the sales manager, salesperson or sales force identifies prospective customers by some vague and imprecise standard, usually by a demographic sorting technique, such as the size or type of business. Each prospect is usually pursued without taking into consideration whether the prospect has any actual need, use or desire for the Goods. This system is not reliable because the potential sales in the pipeline bear almost no relationship to the actual sales for a company; a result primarily due to the fact that the potential customers in the pipeline may not have any need for the Goods, may not be authorized to purchase the Goods, or may be unwilling to purchase the Goods. Consequently, the agent of change may spend significant time and resources pursuing prospects that, in reality, never had a use for the Goods, and trying to close all deals in the pipeline, most of which will never close. This may also result in a salesperson significantly discounting the Goods at the last minute in order to close the sale.

The following are brief examples of commonly touted characteristics used for manipulative selling or molding perceptions:

Price. Most frequently, a salesperson manipulates customers in to buying or something by convincing the customers that the customer cannot beat the price on the Goods for sale.

Quality. Sales personnel may also persuade potential customers into buying their Goods by convincing the customer that their Goods are of higher quality than their competitors', or that their products are simply quite useful or interesting in the abstract.

Convenience. Goods of a particular salesperson may be promoted as being more convenient to the customer than the Goods of the salesperson's competitors.

While these and other characteristics are reasonable competitive advantages, and influence a prospective customer's decision to buy a salesperson's Goods, it does not change the fact that the customer may not need, want, or have the authority to purchase, the Goods. Overlooking these simple, yet significant factors, may result in the waste of tremendous time and resources. Consequently, there is a need for an improved method and system for selling.

### SUMMARY OF THE INVENTION

The present invention focuses on changing perspectives of sales persons, sales managers, sales divisions and other agents of change, from one of “can this deal work” to one of “will this deal work” before a deal is placed in the pipeline or significant resources are expended. The systems and methods of the present invention reduce expenditures of significant time and other resources by not pursuing sales or opportunities that probably will not close. This is accomplished in a general sense, although not exclusively, by qualifying each opportunity for change against strict criteria and pursuing only those opportunities that meet or exceed the strict criteria. Another aspect of the invention is to generate sales leads that are more likely to qualify against the strict criteria. Yet another aspect of the invention includes methods and systems for educating others how to improve the efficiency of success in pursuing opportunities for change. The present invention, while discussed in context of selling Goods, generally relates to making decisions on whether to pursue endeavors to implement a change (pursue opportunities for change), which includes, but is not limited to, a buyer's decision to purchase Goods.

### BRIEF DESCRIPTION OF THE DRAWING

Additional aspects, features and advantages of the present invention will become more apparent from the following description of the drawings in which like references numerals denote like elements and in which:

FIG. 1 illustrates a flow chart detailing a typical method for selling Goods;

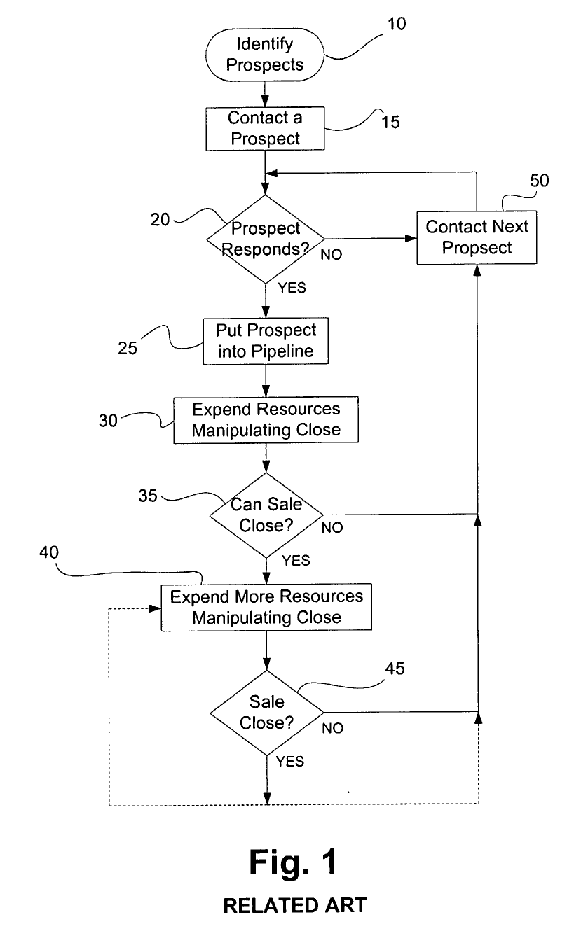

FIG. 2 illustrates a flow chart detailing a method of selling Goods according to one embodiment of the invention;

FIG. 3 illustrates example criterion for qualified selling;

FIG. 4 illustrates a flow chart detailing another embodiment of a method of qualifying opportunities for change;

FIG. 5 illustrates a flow chart detailing a method of qualifying a first parameter for success;

FIG. 6 illustrates a flow chart detailing a method of qualifying a second parameter for success;

FIG. 7 illustrates a flow chart detailing a method of qualifying a third parameter for success;

FIG. 8 illustrates a flow chart detailing a method for qualifying opportunities for change according to another embodiment of the present invention;

FIG. 9 illustrates example inputs for a system of qualifying opportunities for change;

FIG. 10 illustrates a computer-based system of qualifying opportunities for change; and

FIG. 11 illustrates a network-based system of qualifying opportunities for change.

### DETAILED DESCRIPTION OF THE PREFERRED EMBODIMENTS

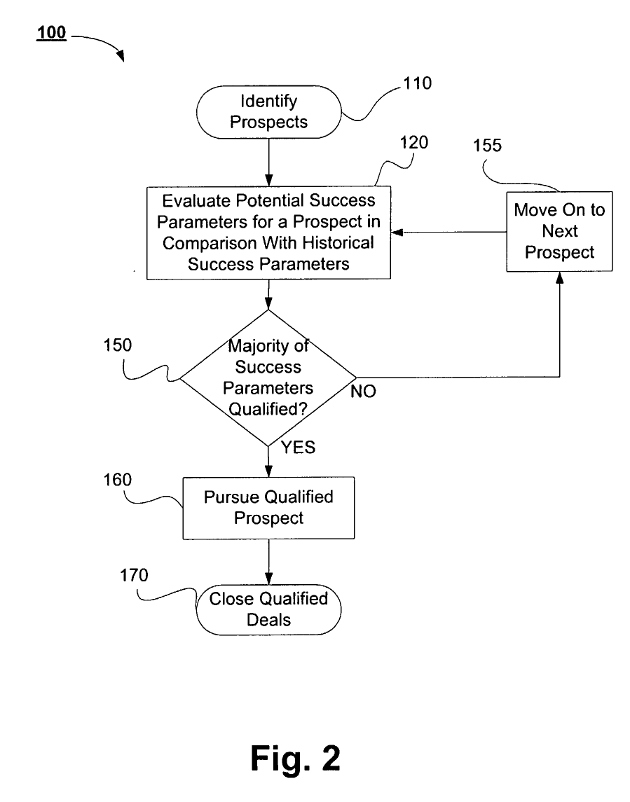

Referring to FIG. 2, a method of qualifying opportunities for change 100 according to one embodiment of the invention will now be described. An agent of change identifies potential prospects or leads for its Goods 110. Merely by way of example, an agent may review news articles or stories looking for leads or prospects that have problems or opportunities reflected by the subject matter of the news articles.

Next, the person or organization evaluates the potential success of the change or opportunity by: (i) quantifying success parameters of the change or opportunity; and (ii) evaluating whether the quantified success parameters meet or exceed a threshold minimum 120. Certain success parameters exist in every opportunity for change, each of which have an impact on whether or not a change will be implemented as detailed further herein.

Historical success parameters may be derived and quantified from model opportunities ending in change (successes) and may be based on either factors of actual past successes or on what one might consider a theoretical success. As an example, historical successes may be sales or other opportunities that have closed in the past or any other type of endeavor that was successful in implementing a change. Actual historical sales may or may not be associated specifically with a present opportunity for change but are preferably at least similar in nature to the present opportunity; for example, a sale of similar goods to a similar type or sized entity as the opportunity for change that is being evaluated. Theoretical successes may be determined based on an ideal sale or theoretical conditions that most often lead to success.

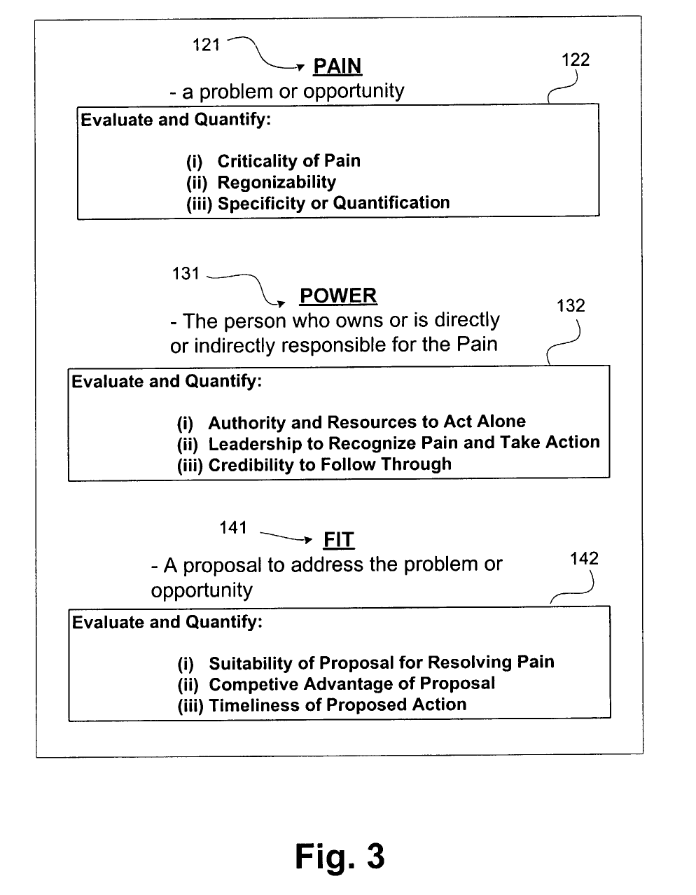

Some specific examples of success parameters are shown in FIG. 3. The success parameters are a model for qualitative analysis of change. In action, the success parameters represent the organizing principles for evaluating the potential of, or crafting an action plan for achieving, any kind of achievement, goal, change or objective. Principle success parameters that exist in every change include but are not limited to: (i) a Pain success parameter 121; (ii) a Power success parameter 123; and (iii) a Fit success parameter 125.

The Pain success parameter 121 is used for evaluating the merits of a problem or opportunity. The Power success parameter 131 is used for evaluating the entity that owns the problem or opportunity or is directly or indirectly responsible therefor. (In the context of selling goods to a buyer, the “Power” is the person that makes the decision to buy.) The “Fit” success parameter 141 is used for evaluating the proposal that addresses the “Pain,” e.g., goods, services, or ideas to address the problem or opportunity with a comparative advantage. These success parameters are present in every opportunity for change, and when evaluated in comparison to similar parameters of previous or theoretical successes, provide reliable qualification indicia as to whether a deal “will” close or be successful.

Referring back to method 100 (FIG. 2), if a majority of success parameters do not qualify in comparison with historical success parameters 150, the salesperson or other “agent of change” does not waste any further time or resources on the present prospect, but instead, moves on to the next prospect 155. Alternatively, if a majority of success parameters do qualify in comparison to historical success parameters, the prospect, or opportunity for change, is further pursued 160 and, unless unforeseen circumstances arise, the deal usually closes or the change is enacted 170.

With this novel approach, a pipeline of qualified sales opportunities can be generated that will more accurately predict sales revenues as compared to the prior art non-qualified sales pipelines. Additionally, resources may be focused on opportunities that “will” close as opposed to expending resources on all possible opportunities, i.e., opportunities that “can” close, but most of which will not.

As discussed in respect to FIG. 3, examples of success parameters include, but are not limited to, a Pain success parameter 121, a Power success parameter 131 and a Fit success parameter 141. Each of these success parameters may be generally or loosely quantified to evaluate whether a deal is worth pursuing. For example, a person may evaluate and assign a numeric value for each success parameter (e.g., a number between one and ten where ten is the ideal situation). If the assigned values exceed a minimum threshold (representing a minimum quantification of parameters required for past or theoretical success), the deal is qualified and pursued; if not, the deal is not qualified and abandoned in favor of a qualified prospect.

In an example of this novel approach, assume an agent of change has ten leads or prospects, only three of which would qualify against historical success parameters. Using the prior art methods, the agent of change would expend time and resources on all ten leads for which, more than likely, only three will actually close. In sharp contrast, an agent of change using the methods of the present invention, would completely ignore the seven non-qualifying opportunities and concentrate only on the three qualified prospects. The overall result is readily recognized; the more qualified sales opportunities an agent of change pursues, the more closed sales or effective changes will be made. Comparatively, the agent of change in this example using the novel approaches of this invention would be over three hundred percent more efficient (100% effective versus 30% percent effective is 333% more efficient) than the agent of change using the prior art techniques.

The present invention is in sharp contrast to, and thus not obvious in light of, the common thinking of agents of change familiar with the prior art methods. This common thinking promotes the idea that by increasing the volume of pursued opportunities; the number of successful sales or changes will also increase. Consequently, the agent of change following this line of reasoning pursues as many opportunities as possible, including non-qualified opportunities. While it is often true that the pursuit of more prospects may increase the number of actual sales, the realization of this truth is derived from the fact that the more prospects the agent of change pursues, the more “qualified prospects” the agent of change will encounter. It is the qualified opportunities that close and thus, using the methods of the present invention (e.g., pursuing only qualified opportunities), the agent of change will be much more efficient and successful as compared to using the prior art methods. Furthermore, prior art methods emphasize learning how to be more expert in the pursuit of these non-qualified opportunities, using techniques aimed at “educating,” or bluntly, aimed at the manipulation of, prospective customers. There is little evidence in the literature that increased expertise in either area of skill (education or manipulation) actually leads to more closed deals. Instead, there is considerable evidence that the manipulation behaviors taught to so many sales professionals has simply given rise among buyers, much as a healthy immune system responds to a viral attack, to increased friction in the sales process in general.

A more accurate quantification may be derived by individually quantifying the varying elements 122, 132, 142 that have an impact on each success parameter 121, 131, 141. These elements are essentially sub parameters that are used in assessing important aspects of each success parameters. For example, Pain success parameter 121 elements 122 may include but are not limited to: (i) the degree to which the problem or opportunity is critical enough to its owner to create movement to action (“critical”); (ii) the ability or willingness of the owner to recognize the problem or opportunity (“recognized”); and/or (iii) the specificity with which the problem or opportunity can be quantified or conveyed to its owner (“specific”). As described in further detail below, elements 122 may be estimated and assigned a numerical value in order to accurately quantify the Pain success parameter 121.

Elements 132 for analyzing the Power success parameter 131, may include evaluating and quantifying, among other things: (i) the person's authority, reach, resources, and/or capability, to act alone on the problem or opportunity (also referred to herein as “wherewithal”); (ii) the person's leadership in recognizing the pain and the level of their intention and propensity to take action to resolve the pain (“leadership”); and (iii) the credibility of the agent with the person with the wherewithal to make the decision (“credibility”). Using elements 132, the Power success parameter 131 may be accurately quantified.

Elements 142 for analyzing the Fit success parameter 141 may include evaluating and quantifying, among other things: (i) the suitability of the proposal for addressing the problem or opportunity within environmental constraints (“suitable”); (ii) the comparative advantage of the proposal over alternative courses of action or, simply, inaction (“advantage”); and (iii) the timeliness of the proposal in addressing the problem or opportunity now or in the immediate future (“timely”). Elements 142 may be used for accurately quantifying Fit success parameter 141.

In planning action, elements 122, 132 and 142 differ in their relative ability to be affected by the agent of change. Elements 122, 132 and 142 fall into three basic categories: (i) Inherent (an agent of change generally does not exercise control over the element, e.g., critical, wherewithal, suitable); (ii) Influenced (an agent has a general capacity to affect their status), e.g., recognized, leadership and advantage; and (iii) Controlled (an agent has the ability and responsibility to control their status, e.g., specific, credibility and timeliness). By way of example, an agent of change may influence, to a certain extent, an owner's ability to “recognize” the problem or opportunity and has great control over their own “specific” articulation of the problem they intend to solve or opportunity they intend to help realize; however, the agent of change has little influence over the inherent “criticality” of the problem or opportunity. To the extent that their behaviors are central to their perceived believability and trustworthiness, the agent of change has significant ability to control his/her “credibility” with the person who owns the problem or opportunity, but little to no influence over the person's “wherewithal” to act. The agent of change has almost no influence over the “suitability” of the Fit success parameter 141 and therefore must carefully evaluate this element with objectivity.

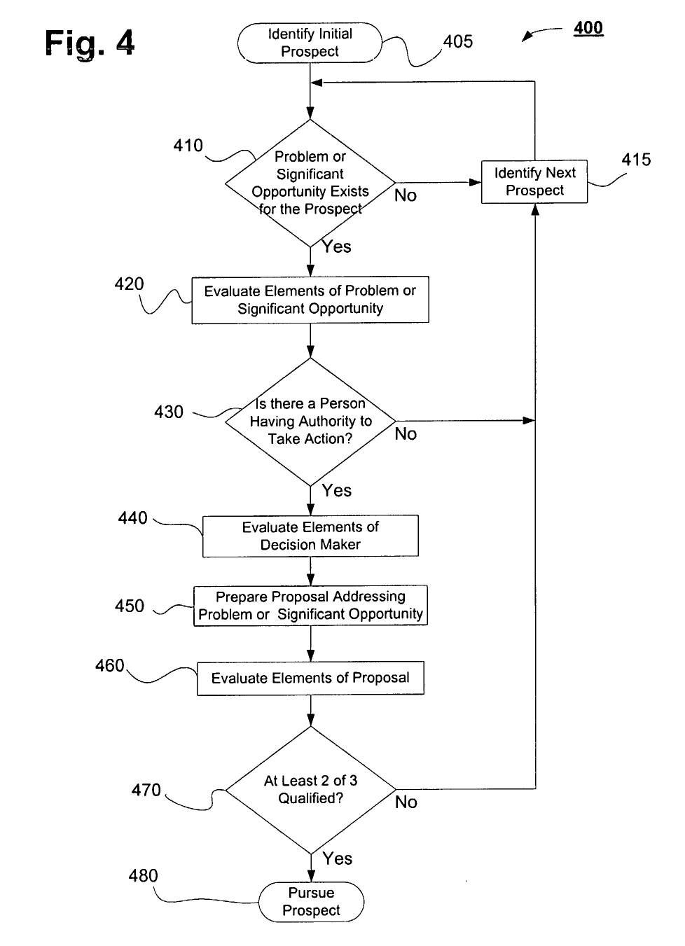

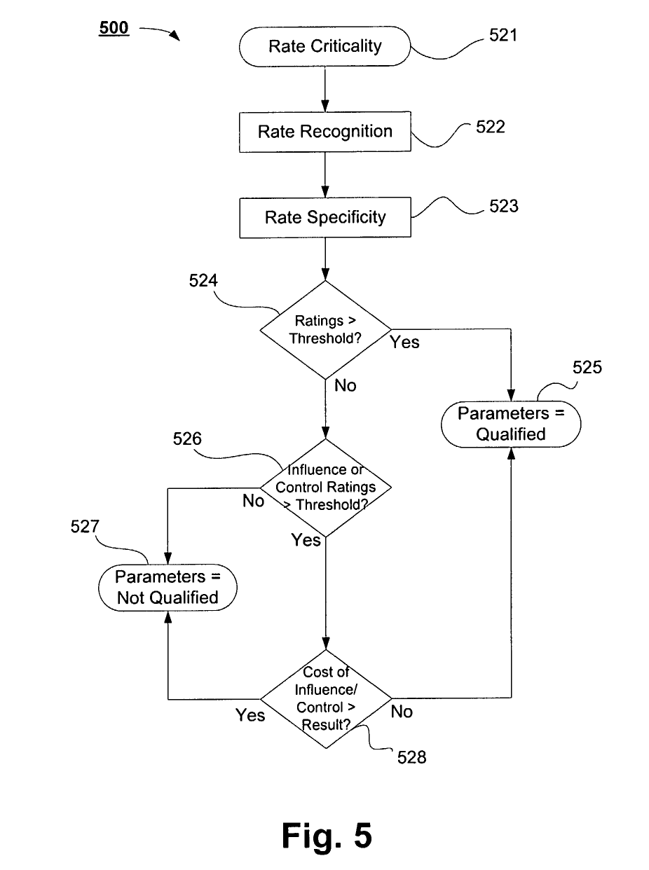

Another method 400 of qualifying opportunities for change will now be discussed in reference to FIG. 4. Method 400 begins by identifying an initial prospect 405 and determining whether a problem or opportunity can be identified for the prospect 410. The problem or opportunity must give some rise of desirability or necessity for the Goods offered by the agent of change. For example, if the agent of change is a computer equipment salesperson, an identified problem might be that the prospect's existing computer equipment is too slow or incapable to meet the demands of current software or networks. An opportunity might be that the prospect is known to be in the market for new computer equipment. If a problem or opportunity cannot be identified for the prospect, the agent of change moves on to the next prospect 415 and begins again. Otherwise, if a problem or opportunity is identified, the agent of change evaluates the elements of the problem or opportunity that are required for a qualified success 420. One example of this evaluation is described below in reference to FIG. 5.

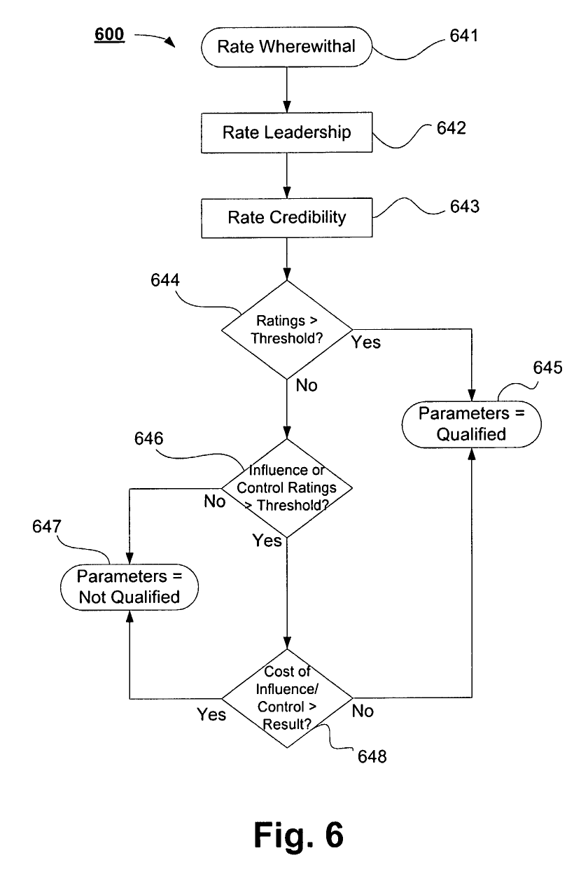

The agent of change also identifies whether there is, and if so who is, a person allocated by the prospect that is responsible for effecting the desired change 430; variously referred to as the “decision maker.” The decision maker may be a purchasing agent, a corporate officer or whoever may be responsible for making the decision to buy the agent's Goods. It should be realized that the targeted decision maker might change during the course of pursuing the prospect, for example, by realizing the person with actual power to make the buying decision is not the originally identified person. Accordingly, as with all of the evaluated parameters and rated elements discussed herein, such evaluation and rating processes may be repeatedly performed throughout the process of pursuing an opportunity for change. If a decision maker cannot be identified, the agent of change moves on the next prospect 415. If a decision maker is identified, the agent of change evaluates the elements of the decision maker that are required for a qualified success 440. One example of evaluating these elements is described in further detail below in reference to FIG. 6.

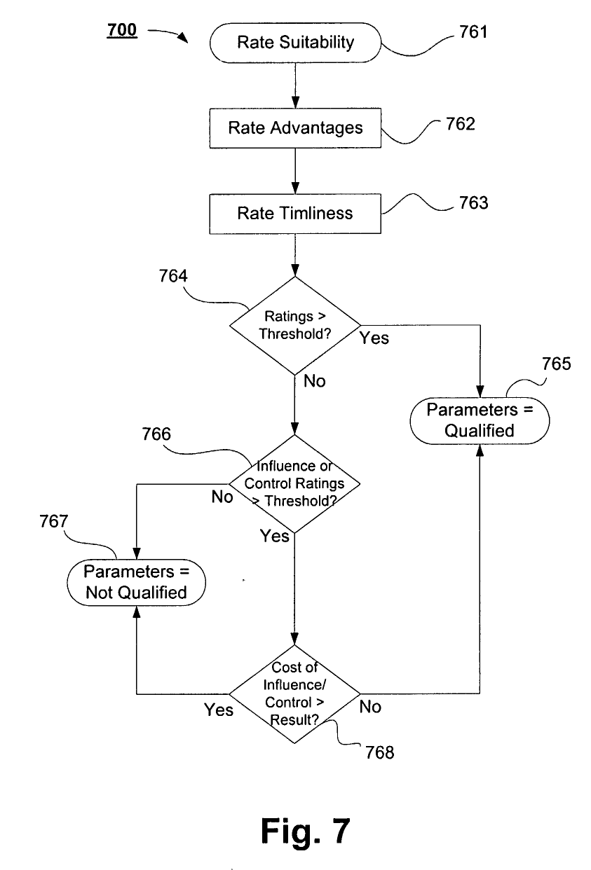

At some point after the problem or opportunity has been identified for the prospect 410, a proposal to address the problem or opportunity with a comparative advantage is prepared or determined by the agent of change 450. The elements for qualifying the success of the proposal may then be evaluated 460. An example of qualifying the proposal as a potential success is described in further detail below in reference to FIG. 7. If at least two of the three evaluated parameters (420, 440 and 460) do not qualify as potential successes when compared to similar parameters of past or theoretical successes 470, the agent of change abandons the prospect in favor of a new prospect 415 and repeats the qualification process 400. Otherwise, if at least two of the three success parameters do qualify with past or theoretical successes, the prospect is further pursued 480.

Examples of methods for evaluating elements and qualifying success parameters will now be described in reference to FIGS. 5-7. A method 500 of qualifying an opportunity for success with respect to an identified problem or opportunity includes an agent of change rating elements that factor into each problem or opportunity. As previously discussed in respect to FIG. 3, these elements may include, but are not limited to, the specificity with which the problem or opportunity may be conveyed to the decision maker, e.g., quantify the problem, the decision maker's ability to recognize the problem or opportunity, and its degree of criticality. Consequently, the agent of change will rate the criticality 521, recognition 522, and specificity elements 523 for the problem or opportunity. Rating these elements may be performed in any manner to grade or denote a magnitude, for example, assigning a number between one and five wherein five is the largest magnitude, etc. The following discussion of these elements may be helpful for rating by an agent of change:

Critical: is there a sufficient cause for movement to action? In rating the criticality of the problem or opportunity, the agent of change may consider: (i) what is the priority of the problem or opportunity in context with the prospect's other problems and opportunities; (ii) what is the return on investment for the prospect in addressing the opportunity or problem; (iii) whether addressing the problem or opportunity will have any effect on other problems or opportunities, e.g., does it forestall, mitigate or magnify other problems; (iv) what is the risk if the prospect ignores the problem or opportunity versus what is the risk if the prospect addresses the problem or opportunity.

Recognized: will the decision maker recognize the problem or opportunity with urgency sufficient to act? In rating this element of the problem or opportunity, the agent of change may consider: (i) how many people are aware of the problem or opportunity, who are they and how influential are they in the decision making process; (ii) how long will the problem or opportunity last and whether this timeframe enhances or reduces recognition; and (iii) how familiar the problem or opportunity, generally or intricately, is to the decision maker or to a decision maker in a similar situation.

Specific: is the problem or opportunity articulated, bounded and quantified so that the risk of change is kept to an acceptable level? In rating this element, an agent of change may consider: (i) whether the economics of the decision maker's environment are properly understood; (ii) quantifying the benefits of change and the concreteness of the quantification; (iii) the various dimensions of the problem and opportunity; and (iv) the degree to which the agent of change's Goods address the problem or opportunity.

Once the elements have been rated 521, 522, 523, the agent of change may determine whether these ratings, individually or collectively, meet or surpass a minimum threshold value that represents the requirements for inexorable change 524. As previously discussed, minimum threshold(s) for success may be derived from analyzing past successes or theoretical successes. If the ratings surpass the minimum threshold 524, the opportunity or problem is “qualified” as meeting success criterion 525. If the ratings do not meet or exceed the threshold minimum, it is determined whether the agent of change may “influence” or “control” the elements to do so 526. As discussed above, since the agent may have influence or control over certain elements, the ratings for these elements may be increased accordingly. For example, if the agent can influence the decision maker's recognition of the opportunity or problem then the rating may be increased. However, even when the agent may adjust the rating of a particular element because of influence or control, and the adjusted ratings will still not meet or exceed the minimum threshold, the success parameter for the opportunity or problem is “not qualified” 527.

If the rating can be adjusted, due to the agent's influence or control over an element, and the adjusted rating is sufficient to meet or exceed the threshold minimum, the agent may optionally determine whether the cost or resources for influencing or controlling the element outweighs the success of the endeavor 528. For example, assume an agent of change could spend amount $A to give a presentation to the decision maker in order to increase the decision maker's recognition of a problem or opportunity; next assume the result of any change or closing the sale will be in the amount $B. If $B does not significantly outweigh $A, then it may not worth the resources for the agent to influence or control the element and the opportunity for success is “not qualified” 527. However, if there is no cost for the agent to influence or control an element, or the cost is minimal as compared with the gain of the endeavor, then the opportunity for success is “qualified” 525.

Turning to FIG. 6, a method 600 of qualifying a decision maker is performed in a similar manner, except with respect to the elements of wherewithal, leadership and credibility.

Wherewithal: is there a decision maker with authority, reach and/or resources sufficient to act alone? In rating this element of the decision maker, the agent of change may consider: (i) what controls exist on the decision maker's behavior (e.g., financial, legal, organizational, political); (ii) who wields these controls; (iii) does the decision maker have formal, specified responsibility for the problem or opportunity; and (iv) how distant is the decision maker from the problem or opportunity (e.g., does the decision maker benefit directly by addressing the pain or will be held responsible for not addressing the pain)?

Leadership: what is this decision maker's intention and propensity to act? In rating this element, the agent of change may consider: (i) what is the performance history of the decision maker in related areas, if known; (ii) what is the prospect's experience with proactive change/reactive change; (iii) what are the personal strengths of the decision maker (e.g., consensus builder, charismatic leader, communication skills, politically savvy); and (iv) what is the decision maker's motivation to act, e.g., personal organizational, altruistic?

Credibility: how credible is the agent of change with the decision maker, and/or the proposal to address the problem or opportunity. In rating this element, the agent of change may consider: (i) what relevant stories the agent of change may have and convey to build rapport; (ii) how familiar are the environment, actors and value proposition; (iii) the differences in communication styles between the decision maker and agent of change; and (iv) what is the relevant track record with the decision maker/prospect?

The agent of change assigns a rating for each of these elements 641, 642 and 643, and compares the ratings with a threshold minimum (determined from theoretic successes or from past successes) 644. If the ratings meet or exceed the threshold minimum, the decision maker parameter is “qualified.” If the ratings do not meet the minimum threshold, the agent evaluates whether certain elements may be influenced or controlled to do so 646, and whether the end result (e.g., closing the sale or implementing the change) is worth the cost of influencing or controlling the elements to meet the threshold 648. If the answer to both of these questions is “yes,” the decision maker is “qualified” 645. If either answer to either of these questions is “no,” the decision maker is deemed “not qualified” 647.

The agent of change may have some influence on the leadership element of the decision maker by, for example, communicating the problem or opportunity, and/or the proposal to address the problem or opportunity, in a manner sufficient to get commitment from the decision maker. Influence over this element may not require any substantial resources from the agent of change. On the other hand, the agent has significant control over its credibility with the decision maker through building rapport with the decision maker. Building rapport may require substantial investments of time and money from the agent of change and thus, it is beneficial to compare the costs that may be associated with controlling credibility with the overall benefits gained from effecting the change before continuing to pursue an opportunity on the borderline of qualifying.

Turning to FIG. 7, a method 700 for qualifying a proposal's fit to the problem or opportunity is performed in a similar manner to the methods as explained in reference to FIGS. 5 and 6, except with respect to the elements of suitability, advantage and timeliness.

Suitable: does the proposal solve the problem or address the opportunity within constraints of the decision maker's environment? In rating this element, the agent of change may consider: (i) has this problem been solved or opportunity been addressed before (how often, how specific, how similar to present circumstance); (ii) is the proposal designed from scratch or retrofitted; (iii) what environmental factors (standards, regulations, laws, etc.) pose potential issues and how can they be overcome; and (iv) what differences exist between the proposal and previous successes and how significant are the differences?

Advantage: does the proposal have a comparative advantage over alternatives? In rating this element, the agent of change may consider: (i) is there a cost benefit or return on investment, how much and how soon; (ii) is there less attendant risk with the proposal, and is quantifiable; (iii) is the proposal the first to-be considered, last or in between; and (iv) does a single decision on the proposal address multiple problems or opportunities?

Timeliness: is the proposal timely in context? In rating this element, the agent may consider: (i) the timeframe required for implementing the proposal and whether it is shorter than average or longer and average; (ii) the optimum time for addressing the problem or opportunity and whether the degree for which the proposal can accomplish this; and (iii) the degree for which the decision maker's circumstances permit implementation of the proposal (e.g., funds available, time of fiscal year, other projects being implemented, etc.)?

The agent of change assigns a rating for each of these elements 761, 762 and 763, and compares the ratings with a threshold minimum (determined from theoretic successes or from past successes) 764. If the ratings meet or exceed the threshold minimum, the proposal parameter is “qualified.” If the ratings do not meet the minimum threshold, the agent evaluates whether certain elements may be influenced or controlled to do so 766, and whether the end result (e.g., closing the sale or implementing the change) is worth the cost of influencing or controlling the elements to meet the threshold 768. If the answer to both of these questions is “yes,” the proposal is “qualified” 765. If either answer to either of these questions is “no,” the proposal is deemed “not qualified” 767.

The agent of change may control the timeliness element of the proposal by, for example, scheduling the change to be implemented around the needs of the decision maker/prospect. Controlling this element may require some resources, e.g., to expedite or delay the change. The agent has some influence over the advantage element of the proposal, for example, by providing a low bid or including extra incentives in the proposal. Consequently, it is beneficial to compare the costs that may be associated with controlling timeliness and influencing advantages with the overall benefits gained from effecting the change, before the proposal is qualified.

The careful, detailed and subjectively quantified methods of evaluating historic and theoretical change proposals as described above will yield the most precise results in using this method. However, in another embodiment of the invention, a more economical method of employing this system involves (i) evaluating which of the nine elements of change have crossed the threshold status in a given change situation; and (ii) preferably in a binary fashion, rating elements properly qualified as “1” and those not qualified as “0.” In this embodiment, every change proposal can be granted an overall rating of from “0” to “9,” with a “9” being, by definition, a change that has already occurred. In this embodiment, a pipeline of opportunities can be categorized by the aggregate rating of each change proposal “0”-“9” and groupings identified that indicate the likelihood of the change ultimately being effected. For example, proposals having a summed rating of “7” or “8” may be considered very likely to be effected; proposals rated “5” or “6” may be rated as worthy of further activity/pursuit; and opportunities rated under “5” may be considered as “unqualified” and hence not worthy of pursuit. Such groupings can provide resource managers with a simple and effective method for evaluating the healthiness of a given change agent's pipeline of opportunities.

Using one or more of the previously described methods (FIGS. 4-7), an agent of change may effectively filter out qualified versus non-qualified opportunities for change and thus, expend resources in pursuing only qualified opportunities. The foregoing methods are most effective when used to model, replicate and scale historical success in any endeavor, including but not limited to, managing projects, developing real estate, selling Goods, crafting legislation or ally other change.

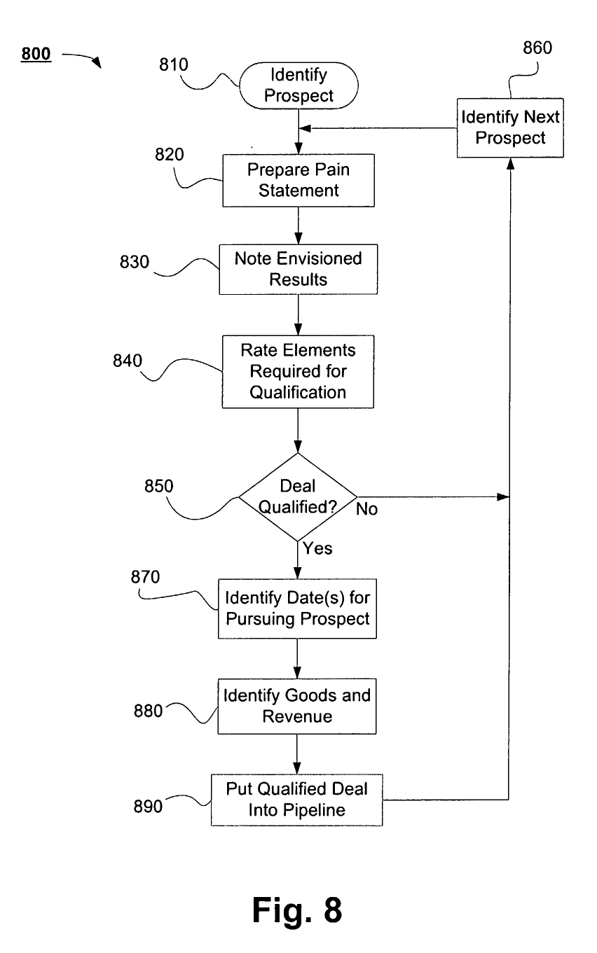

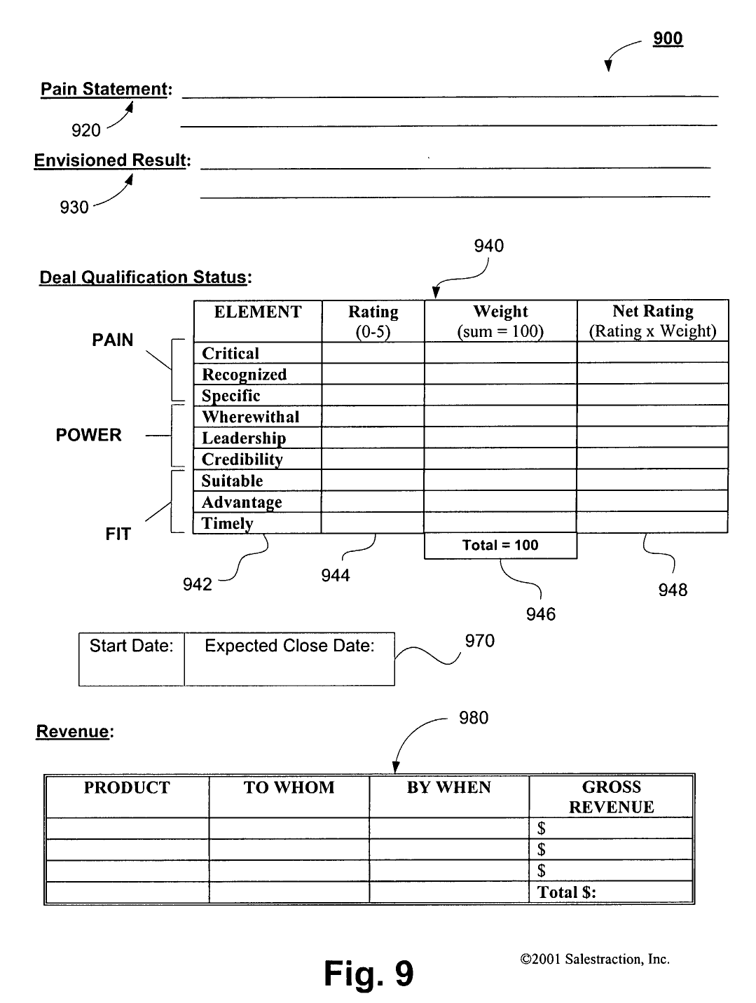

A method 800 and system 900 for instructing others how to qualify opportunities for change will now be described in reference to FIGS. 8-9. A method 800 of qualifying, and instructing others to how to qualify, an opportunity generally includes teaching others to, among other things: (i) identifying a prospect; (ii) preparing a pain statement for the prospect; recording envisioned results; (iii) rating elements associated with the prospect's problem or opportunity, decision maker and/or proposal; (iv) determining whether the opportunity is qualified based on the rating(s); and (iv) pursuing the prospect if the opportunity for change is qualified.

Pain is everywhere. There is no limit to the amount of prospects that can be identified 810 by looking for problems and opportunities that are present everyday around the agent of change. As previously discussed, watching the news, reading magazines, or looking at business journals and newspapers readily identifies pain of prospects.

Once a prospect is identified 810, the agent of change evaluates the pain associated with the problem or opportunity. To this end, the agent of change should think about the aspects and boundaries of each problem or opportunity. A useful way of accomplishing this is to write a “pain statement” (about the problem or opportunity) 820 (FIG. 9; 920). A pain statement is a concise statement written by the agent of change and preferably includes: (i) the identity of who has the “pain”; (ii) a description of the specific problem or opportunity (“pain”); and (iii) a description of a measurable goal for addressing the problem or opportunity. The following is an example of a pain statement:

“Company X has a problem with receiving their orders of widgets on time due to their currently supplier's shipping delays of ten days or more; I can sell the same or better quality widgets at the same or lower cost to Company X without any delay in shipping because my distribution center is located in the same city as Company X.”

By writing the “pain statement,” the agent of change is forced to realize and contemplate: (i) who they may be dealing with, e.g., Company X (this may be helpful in identifying the decision maker and for assessing elements of success, e.g., credibility from previous dealings); (ii) what are the primary reasons Company X needs to change its existing circumstance; and (iii) a quantifiable goal which may be; focused on by the agent, emphasized to the decision maker for implementing the change; as well as, compared with actual results upon implementation of the change. After significant exposure to the methods and systems of the present invention, an agent of change may not need to write the pain statements 820, 920, but rather they will systematically and automatically be derived in the agent's thoughts.

Optionally, the agent of change may record the envisioned result of the change 820 (FIG. 9; 930). For example, “Company X will purchase all of its widgets from us averaging gross sales of $150,000 a year.” This can assist the agent in realizing the potential of the prospect and opportunity for change.

Next, the agent of change qualifies the elements for the problem or opportunity (pain); the decision maker (power); and the proposal (fit) 840. Preferably, this is performed in accordance with methods similar to that described above in reference to FIGS. 4-7.

An example table 940 for qualifying each element is illustrated in FIG. 9. Table 940 is but one example of how these elements may be rated 840 for determining whether the opportunity for change is qualified 850. Table 940, as shown in FIG. 9, may include a column designating each element to be rated 942, a column for rating each element 944, a column for assigning a weight denoting the importance of each element 946 as compared to the remaining elements (e.g., the summed weights of all elements will equal one hundred or 100%), and a column for the net rating of each element 948. Multiplying the rating assigned in column 944 times the weight assigned in column 946 derives the net rating in column 948.

For determining whether the opportunity for success is qualified 850 (FIG. 8), the agent of change may compare each net rating with a corresponding minimum threshold required for qualification. Alternatively, the net ratings for each element may be summed and a total net rating may be compared against a total threshold rating for determining whether the opportunity for change is qualified. Each minimum threshold or the total threshold rating may be derived by analyzing one or more past successes, for example, using table 940. Analyzing one or more past successes that almost failed would give the most accurate minimum thresholds.

If the opportunity is not qualified against the criterion described above, the agent of change will “walk away” from the current prospect and move oil to the next prospect 860. However, if the opportunity for change is qualified, the agent of change may optionally, identify the dates for pursuing and implementing the change 870 (FIG. 9; 970), and record the anticipated Goods exchanged and revenue derived from implementation of the change 880; system 900 may include a table 980 to accomplish this end. Once the opportunity for change has been qualified, if applicable, the agent of change may place the opportunity in a pipeline of other qualified opportunities 890. Information gathered and evaluated in method 800 and system 900 may be useful for tracking numbers and other information of an agents past performance and opportunities. Additionally this information may be used for projection sales, revenue, earnings and/or performance based on qualified opportunities that exist in a pipeline. To this end, a pipeline may be created which accurately predicts that performance of an organization to a degree, which has heretofore been non-existent.

System 900 may be implemented using paper format or may be implemented in electronic version. For example, any of the methods and systems of the present invention may be implemented as interactive computer software, that when executed by a computer processor, facilitates entry of information, processing of ratings and comparison or ratings with historical success data.

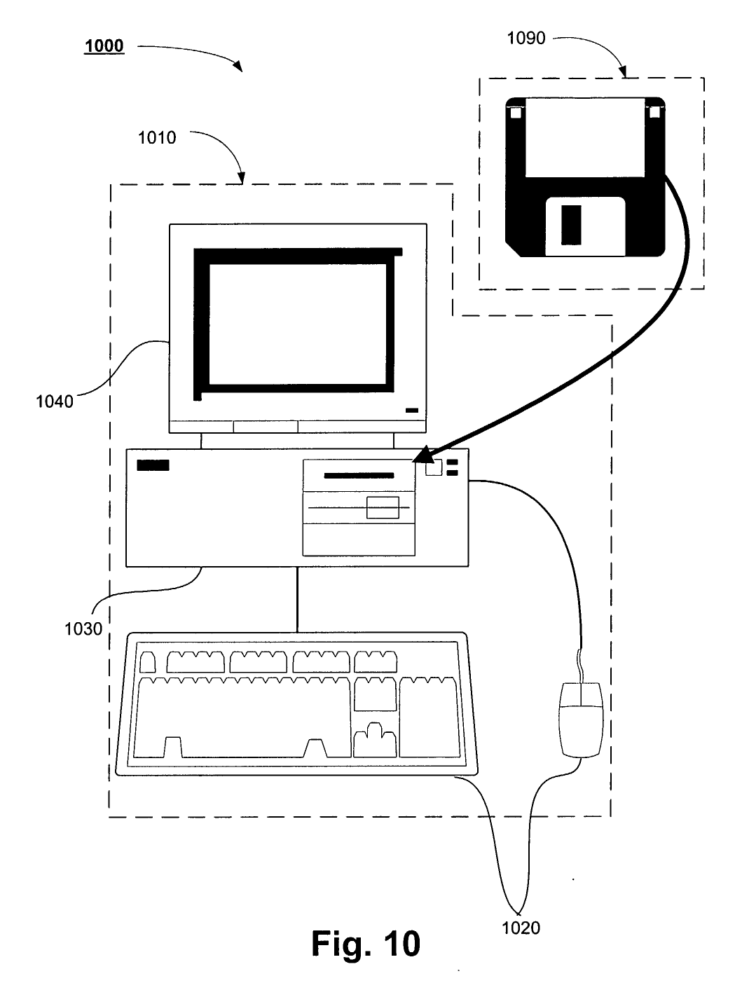

Referring to FIG. 10, a computer based system 1000 for determining qualified opportunities preferably includes a hardware component 1010 and a software or firmware component 1090. The hardware component preferably include: (i) an input device 1020 for inputting prospect information; (ii) a processing device 1030 for processing the inputted prospect information and comparing the prospect information with stored historical information to output qualifying information; (iii) a storage device (not separately shown) for storing the historical information and storing processed information; and (iv) an output device 1040 for outputting or displaying the qualifying information. The software or firmware component 1090 preferably includes machine readable code stored on a tangible medium, that when executed by the processing device, instructs the processing device to process, compare, retrieve, output and/or store the aforementioned types of information.

Input device 1020 may be any device or combination of devices for facilitating input of information about an opportunity for change including, but not limited to, a keyboard, mouse, microphone, or data scanner. Processing device 1030 may be any portable or fixed device, or combination of devices, capable of retrieving inputted data, processing data and generating an output including, but not limited to, a microprocessor, micro-controller, or programmable logic array. The storage device may be any single memory device or combination of memory devices capable of storing information including, but not limited to, a fixed RAM or ROM, or hard drive as well as any removable storage device(s) such as an optical, magnetic or electronic memory device(s). Output device 1040 is one or more devices capable of displaying an output generated by the processing device including, but not limited to, a printer, a CRT, a LCD, a speaker, or a plasma display.

The machine-readable code of software component 1090 may be stored on any tangible medium and programmed using any known or existing computer language to perform the functions outlined above. Using computer based system 1000, an agent of change may quickly input, process and compare a current opportunity for change with past opportunities that may be stored in a memory accessible by processing device 1030, to determine whether a current opportunity is qualified. Software component 1090 may also include machine-readable code for assisting an agent of change in navigating and learning the methods of determining opportunities disclosed herein. Such code may be implemented using retrievable “help files” and/or as an automated tutorial process for guiding a user through each action/input.

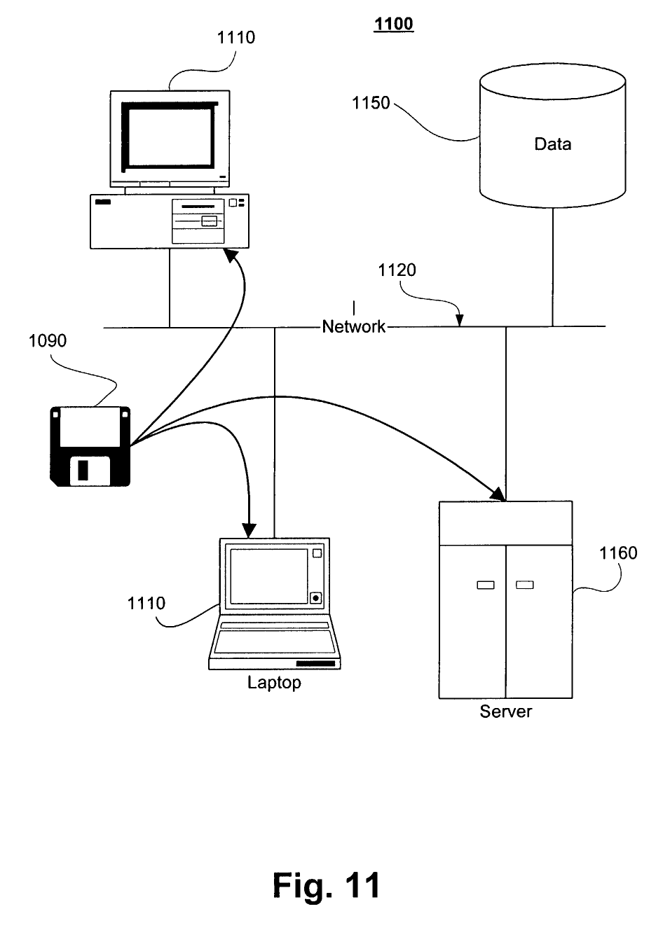

Referring to FIG. 11, a network 1100 utilizing computer based system 1000 for determining qualified opportunities may include: (i) one or more terminals 1110 (which may or may not include all of the hardware components discussed above); (ii) a communications network 1120, such as a LAN or WAN (e.g., Internet or intranet); (iii) an external data storage device (e.g., network or server accessible database) 1150; and (iv) a network computing device 1160 (which may perform any required processing, retrieval, storage and output functions). Network 1100, is preferably configured and operable to enable an agent of change to input data about an opportunity for change and compare the inputted data with minimum thresholds stored in a centralized and/or distant location (e.g., external data storage 1150, and/or server 1160). Additionally network 1100 may preferably store results of the agent's qualification inquiry in a centralized location.

Depending on the requirements and/or desires of the agent of change/agent's organization, software component 1090 may be configured as a distributed program, i.e., having various components of the software residing on various network devices.

As with all of the methods and systems of the present invention, it may be desirable to include a follow-up component/action whereby the agent of change, after a qualified opportunity is pursued, records whether the opportunity resulted in a success or failure. This component/action may assist in fine tuning the minimum threshold discussed above.

The present invention, in addition to the methods and systems for qualifying opportunities disclosed herein, also encompasses methods and systems for teaching or instructing others to do the same. For example, methods of teaching how and why to qualify opportunities may include utilization of flash cards, in-person seminars, instructive software, games, books, videos and audio recordings as well as on-line training.

Unless contrary to physical possibility, the inventors envision the methods and systems described herein: (i) may be performed in any sequence and/or combination; and (ii) the components of respective embodiments combined in any manner.

Although there have been described preferred embodiments of this novel invention, the skilled artisan will recognize that many variations and modifications are possible within the scope of the invention and the embodiments described herein are not limited by the specific disclosure above, but rather should be limited only by the scope of the appended claims.

What is claimed is:

1. A method of qualifying an opportunity for change comprising:
assigning ratings to a plurality of success parameters for the opportunity of change;
comparing the assigned ratings to a minimum threshold, the minimum threshold representing a threshold of success parameters present in a successful endeavor; and
designating the opportunity for change as a qualified opportunity if a majority of assigned ratings are equal to or greater than the minimum threshold.

2. The method of claim 1 wherein the plurality of success parameters comprises three parameters, each of the three parameters representing various merits of every opportunity for change.

3. The method of claim 2 wherein the three parameters comprise a first success parameter representing merits of a problem or opportunity; a second success parameter representing merits of a decision maker; and a third success parameter representing merits of a proposal to address the problem or opportunity.

4. The method of claim 1 wherein the minimum threshold comprises ratings derived from a previous success.

5. The method of claim 1 wherein the minimum threshold comprises ratings derived from a theoretical success.

6. The method of claim 2 wherein assigning ratings to the plurality of success parameters comprises:
rating two or more elements for each success parameter.

7. The method of claim 3 wherein assigning ratings to the plurality of success parameters comprises:
rating two or more elements of the first success parameter;
rating two or more elements of the second success parameter; and
rating two or more elements of the third success parameter.

8. The method of claim 7 wherein three elements are rated for the first success parameter, the three elements comprising: (i) a critical element; (ii) a recognition element; and (iii) a specificity element.

9. The method of claim 7 wherein three elements are rated for the second success parameter, the three elements comprising: (i) a wherewithal element; (ii) a leadership element; and (iii) credibility element.

10. The method of claim 7 wherein three elements are rated for the third success parameter, the three elements comprising: (i) a suitable element; (ii) an advantage element; and (iii) a timeliness element.

11. The method of claim 6 wherein, comparing and designating are performed by a processing device executing machine-readable code.

12. A method of selling Goods comprising:
identifying one or more prospects for the Goods;
evaluating potential success information for a first prospect;
comparing the evaluated potential success information with corresponding historical success information, the historical success information derived from one or more historical successes; and
if the compared evaluated potential success information meets or exceeds the historical success information, (i) pursuing a sale of Goods to the first prospect, else (ii) abandoning pursuit of the first prospect.

13. The method of claim 12 wherein the potential success information comprises a plurality of elements relating to three aspects of a potential sale.

14. The method of claim 13 wherein the three aspects comprise a first aspect relating to a problem or opportunity, a second aspect relating to a decision maker, and a third aspect relating to a proposal's fit in addressing the problem or opportunity.

15. The method of claim 14 wherein the plurality of elements comprises three elements for each aspect including: critical, recognition and specificity elements for the first aspect; wherewithal, leadership and credibility elements for the second aspect; and suitability, advantage and timeliness elements for the third aspect.

16. The method of claim 12 wherein comparing the evaluated potential success information with corresponding historical success information is performed using a processing device executing machine readable code.

17. The method of claim 12 wherein pursuing the sale of Goods to the first prospect comprises designating the sale of Goods to the first prospect into a sales pipeline as a qualified opportunity.

18. A method of teaching others, using a medium of expression, to qualify an opportunity for change, the method comprising:
instructing others to identify information about the opportunity for change;
instructing others to assign ratings for certain characteristics of the opportunity for change;
instructing others how to compare assigned ratings with one or more minimum thresholds, the one or more minimum thresholds representing minimum criteria required for implementing a change; and
instructing others to deem the opportunity for change as qualified if the assigned ratings meet or exceed the one or more minimum thresholds.

19. The method of claim 18 wherein the certain characteristics comprise a plurality of elements relating to three aspects of the opportunity for change including a first aspect pertaining to a problem or opportunity, a second aspect pertaining to a decision maker, and a third aspect pertaining to a fit of a proposal to address the problem or opportunity.

20. The method of claim 19 wherein the plurality of elements comprises three or more elements for each aspect including: critical, recognition and specificity elements for the first aspect; wherewithal, leadership and credibility elements for the second aspect; and suitability, advantage and timeliness elements for the third aspect.

21. The method of claim 18 wherein the medium of expression comprises one of, a computerized tutorial, an in-person seminar, an online training course, an audio recording and a video recording.

22. A system for evaluating an opportunity for change, the system comprising:
a medium for accepting user input of:
(i) information about the opportunity for change; and
(ii) a plurality of ratings regarding characteristics of opportunity for change;
wherein each of the plurality of ratings is assigned a value by a user, the value corresponding to a magnitude of which the corresponding element is present in the opportunity for change.

23. The system of claim 22 wherein the medium comprises a paper medium including one or more sheets of paper having spaces for the user to input ratings for the characteristics of the opportunity for change including criticality, recognition, specific, wherewithal, leadership, credibility, suitable, advantage and timely.

24. The system of claim 22 wherein the medium comprises an electronic medium comprising input means for inputting the general information and the plurality of ratings for the characteristics of criticality, recognition, specific, wherewithal, leadership, credibility, suitable, advantage and timeliness.

25. The system of claim 24 further comprising:
storage means for storing inputted information and storing other information;
processing means for comparing the inputted ratings with stored other information to determine whether the opportunity for change is qualified; and
output means for outputting information regarding the comparison.

26. The system of claim 24 further comprising network connection means for storing or outputting information to, or retrieving information from, a remote location.

27. A method of selling comprising:
identifying at least one prospect;
identifying a problem or opportunity that exists for the prospect;
rating at least two characteristics of the problem or opportunity;
identifying a decision maker for the prospect;
rating at least two characteristics of the decision maker;
determining a proposal to address the problem or opportunity;
rating at least two characteristics of the proposal;
comparing the rated characteristics with one or more minimum thresholds; and
designating the prospect as being a qualified opportunity if the rated characteristics meet or exceed the one or more minimum thresholds.

28. The method of claim 27 wherein, if the rated characteristics do not meet or exceed the one or more minimum thresholds, the method further comprises:
determining whether any of the rated characteristics may be influenced or controlled to meet or exceed the one or more minimum thresholds; and
(i) if so, determining whether costs associated with influencing or controlling the rated characteristics negate any benefits derived from a sale, and if the costs do not negate the benefits, designating the prospect as the qualified opportunity.

29. The method of claim 27 wherein three characteristics are rated for the problem or opportunity including: (i) criticality, (ii) recognition and (iii) specificity.

30. The method of claim 27 wherein three characteristics are rated for the decision maker including: (i) wherewithal, (ii) leadership and (iii) credibility.

31. The method of claim 27 wherein three characteristics are rated for the proposal including: (i) suitability, (ii) advantage and (iii) timeliness.
